(19) United States
(12) Patent Application Publication
(10) Pub. No.: US 2006/0290827 A1
(43) Pub. Date: Dec. 28, 2006

(54) LIQUID CRYSTAL DISPLAY DEVICE

(75) Inventors: Masahiro KIHARA, Osaka-shi, Osaka (JP); Yoshihisa TAGUCHI, Osaka-shi, Osaka (JP)

Correspondence Address: SHARP KABUSHIKI KAISHA;C/O KEATING & BENNETT, LLP, 8180 GREENSBORO DRIVE, SUITE 850, MCLEAN, VA, 22102, US

(73) Assignee: SHARP KABUSHIKI KAISHA, Osaka (JP)

(21) Appl. No.: 11/420,252

(22) Filed: May 25, 2006

(30) Foreign Application Priority Data
May 30, 2005 (JP) 2005-158069

(51) Int. Cl. G02F 1/1343

(52) U.S. Cl. 349/38

(57) ABSTRACT

The invention relates to a liquid crystal display device, and an object is to provide a liquid crystal display device capable of providing high display quality. A liquid crystal display device has first and second TFTs disposed in the vicinity of the crossing point of an nth gate bus line and a drain bus line, a first pixel electrode electrically connected to the first TFT, a second pixel electrode electrically connected to the second TFT and separated from the first pixel electrode, a third TFT whose source electrode is electrically connected to the second pixel electrode, and a buffer capacitance portion. The buffer capacitance portion is provided with a square first buffer capacitance electrode electrically connected to the drain electrode of the third TFT and a square second buffer capacitance electrode opposed to the first buffer capacitance electrode via an insulating film and electrically connected to a storage capacitance bus line.

### BACKGROUND OF THE INVENTION

1. Field of the Invention

The present invention relates to a liquid crystal display device. In particular, the invention relates to a liquid crystal display in which each pixel is divided into plural subpixels.

2. Description of the Related Art

Liquid crystal display devices are widely employed in electronic apparatus such as TV receivers, notebook PCs (personal computers), desktop computers, PDAs (portable terminals), and cell phones because of their advantages that they are thinner and lighter than CRTs (cathode-ray tubes) and can be driven at a low voltage and hence is low in power consumption. In particular, active matrix liquid crystal display devices in which TFTs (thin-film transistors) as switching elements are provided for the respective pixels (or subpixels) have come to be used widely in such fields as desktop PCs and TV receivers in which CRTs have been used conventionally, because they have a high driving capability and hence exhibit superior display characteristics that are equivalent to the display characteristics of CRTS.

In the above uses, liquid crystal display devices are required to exhibit a superior viewing angle characteristic that the display screen is viewable from all directions. MVA (multi-domain vertical alignment) liquid crystal display devices are known as ones capable of providing a wide viewing angle. MVA liquid crystal display devices can realize a superior viewing angle characteristic because each pixel area has plural domains having different liquid crystal molecule alignment directions.

In vertical alignment type liquid crystal display devices such as MVA liquid crystal display devices in which liquid crystal molecules are aligned perpendicularly to the substrates, optical switching is performed by mainly utilizing the birefringence of the liquid crystal. In general, in vertical alignment type liquid crystal display devices, since light traveling in the normal direction of the display screen and light traveling in a direction oblique to the normal direction are different from each other in the birefringence-induced phase difference, the gradation-luminance characteristic (Y characteristic) deviates from a setting curve in the entire gradation range when the screen is viewed obliquely though the deviation depends on various factors. As a result, the relationship between the transmittance and the voltage applied to the liquid crystal (T-V characteristic) when the display screen is viewed from its normal direction is different from that when the display screen is viewed from a direction oblique to the normal direction. This causes a phenomenon that the screen looks whitish when viewed obliquely because of distortion in the T-V characteristic, even if the T-V characteristic is optimized for the normal direction. This phenomenon is called “wash-out.”

Liquid crystal display devices having what is called a halftone-structure in which each pixel is divided into a subpixel A and a subpixel B and different voltages are applied to the liquid crystal in the subpixel A and that in the subpixel B have been proposed as one means for suppressing the wash-out phenomenon. Halftone-structure liquid crystal display devices can suppress the wash-out phenomenon because different Y characteristics introduced in each pixel can decrease the deviation of the birefringence-induced phase difference when the screen is viewed obliquely from that when the screen in viewed squarely.

FIG. 5 shows a pixel configuration of a halftone-structure liquid crystal display device. As shown in FIG. 5, a TFT substrate has plural gate bus lines 12 formed on a glass substrate 10 and plural drain bus lines 14 which are formed so as to cross the gate bus lines 12 with an insulating film such as an SiN film interposed in between. The plural gate bus lines 12 are scanned sequentially. FIG. 5 shows an nth gate bus line 12n which is scanned nthly and an (n+1)th gate bus line 12(n+1) which is scanned (n+1)thly.

A first TFT (thin-film transistor) 21 and a second TFT 22 are disposed adjacent to each other in the vicinity of the crossing position of the gate bus line 12n and a drain bus line 14 (the first TFTs 21 and the second TFTs 22 are provided for the respective pixels). Portions of the gate bus line 12n serve as gate electrodes of the first TFT 21 and the second TFT 22. An operation semiconductor layer 21c of the first TFT 21 and an operation semiconductor layer 22c of the second TFT 22 are formed over the gate line 12n with the insulating film interposed in between. Channel protection films (not shown) are formed on the operation semiconductor layers 21c and 22c, respectively. A combination of a drain electrode 21a and an underlying n-type impurity semiconductor layer (not shown) and a combination of a source electrode 21b and an underlying n-type impurity semiconductor layer (not shown) are formed on the channel protection film of the TFT 21 so as to be opposed to each other with a prescribed gap. A combination of a drain electrode 22a and an underlying n-type impurity semiconductor layer (not shown) and a combination of a source electrode 22b and an underlying n-type impurity semiconductor layer (not shown) are formed on the channel protection film of the TFT 22 so as to be opposed to each other with a prescribed gap. The drain electrode 21a of the TFT 21 and the drain electrode 22a of the TFT 22 are electrically connected to the drain bus line 14. The TFTs 21 and 22 are provided in parallel. A dielectric protective film (not shown) such as an SiN film is formed above the TFTs 21 and 22 so as to cover the entire substrate.

A storage capacitance bus line 18n is formed so as to extend parallel with the gate bus line 12n across the pixel area that is defined by the gate bus lines 12n and 12(n+1) and the drain bus lines 14. A storage capacitance electrode 19 is formed over the storage capacitance bus line 18n with the insulating film interposed in between (the storage capacitance electrodes 19 are provided for the respective pixels). The storage capacitance electrode 19 is electrically connected to the source electrode 21b of the TFT 21 via a connection electrode 25. A first storage capacitor is formed between the storage capacitance bus line 18n and the storage capacitance electrode 19 which are opposed to each other via the insulating film.

The pixel area that is defined by the gate bus lines 12n and 12(n+1) and the drain bus lines 14 is divided into a subpixel A and a subpixel B. In FIG. 5, the subpixel A, which has a trapezoidal shape, for example, is disposed at the center in the top-bottom direction on the left side in the pixel area. The subpixel B occupies regions of the pixel area excluding the subpixel A, that is, a top region, a bottom region, and a central, right end region. In the pixel area, for example, the subpixels A and B are disposed so as to be approximately line-symmetrical with respect to the storage capacitance bus line 18n. A pixel electrode 16 is formed in the subpixel A, and a pixel electrode 17 which is electrically isolated from the subpixel 16 is formed in the subpixel B. Each of the pixel electrodes 16 and 17 is a transparent conductive film made of ITO or the like. The pixel electrode 16 is electrically connected to the storage capacitance electrode 19 and the source electrode 21b of the TFT 21 through a contact hole 24 which is formed through the protective film. The pixel electrode 17 is electrically connected to the source electrode 22b of the TFT 22 through a contact hole 26 which is formed through the protective film. The pixel electrode 17 has a portion that coextends with a portion of the storage capacitance bus line 18n with the protective film and the insulating film interposed in between. A second storage capacitor is formed between those portions of the pixel electrode 17 and the storage capacitance bus line 18n which are opposed to each other via the protective film and the insulating film.

In FIG. 5, a third TFT 23 is disposed below the pixel area (the third TFTs 23 are provided for the respective pixel areas). The gate electrode of the TFT 23 is electrically connected to the next-stage gate bus line 12(n+1). An operation semiconductor layer 23c is formed over the gate electrode with the insulating film interposed in between. A channel protection film (not shown) is formed on the operation semiconductor layer 23c. A combination of a drain electrode 23a and an underlying n-type impurity semiconductor layer (not shown) and a combination of a source electrode 23b and an underlying n-type impurity semiconductor layer (not shown) are formed on the channel protection film so as to be opposed to each other with a prescribed gap.

The source electrode 23b of the TFT 23 is electrically connected to the pixel electrode 17 through a contact hole 27. A right-triangle-shaped buffer capacitance electrode 128b is disposed in the vicinity of the TFT 23. The buffer capacitance electrode 128b is electrically connected, via a connection electrode 35, to a storage capacitance bus line 18(n+1) (not shown in FIG. 5) which is disposed between the gate bus line 12(n+1) and a gate bus line 12(n+2). Since all the storage capacitance bus lines 18 are given the same potential, even if the buffer capacitance electrode 128b is connected to the next-stage storage capacitance bus line 18(n+1) the potential of the buffer capacitance electrode 128b is the same as in a case that it is connected to the storage capacitance bus line 18n. A right-triangle-shaped buffer capacitance electrode 128a is disposed over the buffer capacitance electrode 128b with the insulating film interposed in between. The buffer capacitance electrode 128a is electrically connected to the drain electrode 23a. The buffer capacitance electrodes 128a and 128b which are opposed to each other and that portion of the insulating film which is sandwiched between them constitute a buffer capacitance portion 128, where a buffer capacitor Cb is formed. The drain electrode 23a of the TFT 23 and the storage capacitance bus line 18(n+1) are connected to each other indirectly via the buffer capacitor Cb (capacitive coupling).

As described above, the liquid crystal display device of FIG. 5 is such that the three TFTs 21, 22, and 23 are provided for each pixel. This structure of a liquid crystal display device will be hereinafter referred to as “3-TFT halftone structure.”

However, the area of the buffer capacitance electrodes 128a varies from one pixel to another for reasons relating to a manufacturing process. This results in a problem that the capacitance of the buffer capacitor Cb varies to cause display unevenness.

Related prior art references are JP-A-2-12, U.S. Pat. No. 4,840,460, Japanese Patent No. 3,076,938, JP-A-2004-78157, JP-A-2003-255303, and JP-A-2005-3916.

### SUMMARY OF THE INVENTION

An object of the present invention is to provide a liquid crystal display device capable of providing high display quality.

The above object can be attained by a liquid crystal display device comprising plural gate bus lines formed on a substrate so as to extend parallel with each other; plural drain bus lines which cross the gate bus lines with an insulating film interposed in between; plural storage capacitance bus lines extending parallel with the gate bus lines; first and second thin-film transistors disposed in the vicinity of a crossing point of an nth gate bus line and one of the drain bus lines; a first pixel electrode electrically connected to the first thin-film transistor; a second pixel electrode electrically connected to the second thin-film transistor and separated from the first pixel electrode; a third thin-film transistor which is disposed in the vicinity of a crossing point of an (n+1)th gate bus line and another of the drain bus lines and whose source or drain electrode is electrically connected to the second pixel electrode; and a buffer capacitance portion comprising a first buffer capacitance electrode which is electrically connected to the drain or source electrode of the third thin-film transistor and shaped like a regular polygon having four or more sides, and a second buffer capacitance electrode which is opposed to the first buffer capacitance electrode via the insulating film, electrically connected to one of the storage capacitance bus lines, and shaped like a regular polygon having four or more sides.

In the above liquid crystal display device, a circular first buffer capacitance electrode may be provided in place of the first buffer capacitance electrode shaped like a regular polygon having four or more sides and a circular second buffer capacitance electrode may be provided in place of the second buffer capacitance electrode shaped like a regular polygon having four or more sides.

As such, the invention can realize a liquid crystal display device capable of providing high display quality.

### BRIEF DESCRIPTION OF THE DRAWINGS

FIG. 1 schematically shows the configuration of a liquid crystal display device according to a first embodiment of the present invention;

FIG. 2 shows a one-pixel configuration of the liquid crystal display device according to the first embodiment of the invention;

FIG. 3 shows a one-pixel equivalent circuit of the liquid crystal display device according to the first embodiment of the invention;

FIG. 4 shows a one-pixel configuration of a liquid crystal display device according to a second embodiment of the invention; and

FIG. 5 shows the one-pixel configuration of a conventional liquid crystal display device.

### DESCRIPTION OF THE PREFERRED EMBODIMENTS

### First Embodiment

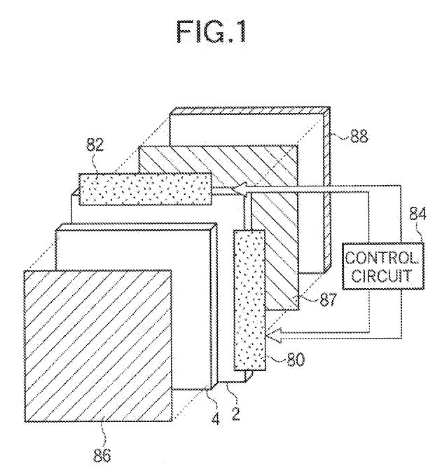

A liquid crystal display device according to a first embodiment of the present invention will be described below with reference to FIGS. 1-3. FIG. 1 schematically shows the configuration of the liquid crystal display device according to this embodiment. As shown in FIG. 1, the liquid crystal display device is equipped with a TFT substrate 2, a counter substrate 4, and a liquid crystal layer (not shown) which is sealed between the two substrates 2 and 4.

A gate bus line drive circuit 80 incorporating a driver IC for driving plural gate bus lines and a drain bus line drive circuit 82 incorporating a driver IC for driving plural drain bus lines are connected to the TFT substrate 2. The drive circuits 80 and 82 output scanning signals or data signals to prescribed gate bus lines or drain bus lines according to prescribed signals which are output from a control circuit 84. A polarizing plate 87 is disposed on that surface of the TFT substrate 2 which is opposite to its TFT element formation surface. A polarizing plate 86 is disposed on that surface of the counter substrate 4 which is opposite to its common electrode formation surface. The polarizing plates 86 and 87 are in the crossed Nicols arrangement. A backlight unit 88 is disposed on that surface of the polarizing plate 87 which is opposite to its surface facing the TFT substrate 2.

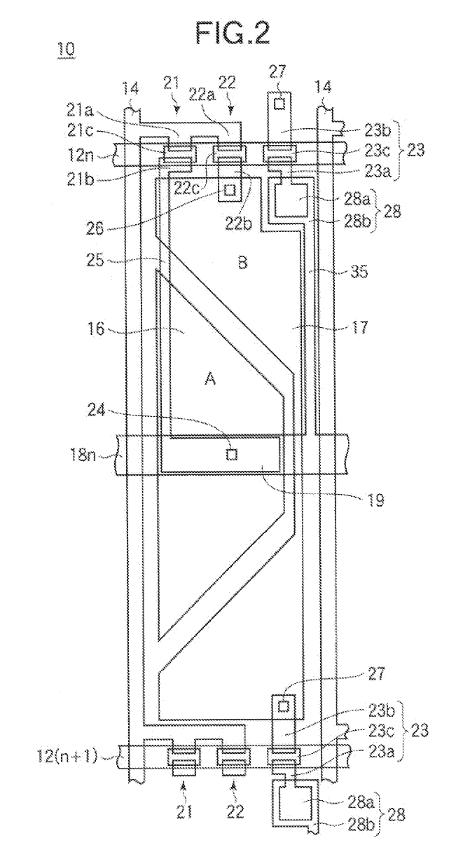

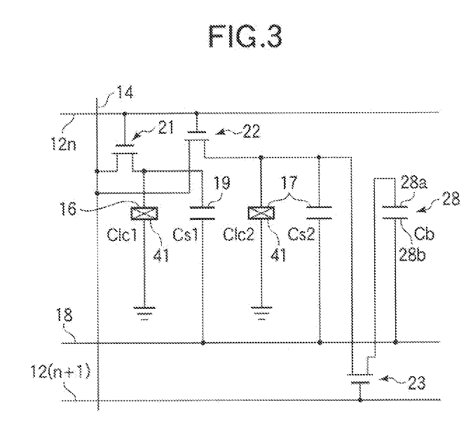

FIG. 2 shows a one-pixel configuration of the liquid crystal display device according to the embodiment. FIG. 3 shows a one-pixel equivalent circuit of the liquid crystal display device. As shown in FIGS. 2 and 3, the TFT substrate 2 has plural gate bus lines 12 formed on a glass substrate 10 and plural drain bus lines 14 which are formed so as to cross the gate bus lines 12 with an insulating film such as an SiN film interposed in between. The plural gate bus lines 12 are scanned sequentially. FIG. 2 shows an nth gate bus line 12n which is scanned nthly and an (n+1)th gate bus line 12(n+1) which is scanned (n+1) thly.

A first TFT (thin-film transistor) 21 and a second TFT 22 are disposed adjacent to each other in the vicinity of the crossing position of the gate bus line 12n and a drain bus line 14 (the first TFTs 21 and the second TFTs 22 are provided for the respective pixels). Portions of the gate bus line 12n serve as gate electrodes of the first TFT 21 and the second TFT 22. An operation semiconductor layer 21c of the first TFT 21 and an operation semiconductor layer 22c of the second TFT 22 are formed over the gate line 12n with the insulating film interposed in between. Channel protection films (not shown) are formed on the operation semiconductor layers 21c and 22c, respectively. A combination of a drain electrode 21a and an underlying n-type impurity semiconductor layer (not shown) and a combination of a source electrode 21b and an underlying n-type impurity semiconductor layer (not shown) are formed on the channel protection film of the TFT 21 so as to be opposed to each other with a prescribed gap. A combination of a drain electrode 22a and an underlying n-type impurity semiconductor layer (not shown) and a combination of a source electrode 22b and an underlying n-type impurity semiconductor layer (not shown) are formed on the channel protection film of the TFT 22 so as to be opposed to each other with a prescribed gap. The drain electrode 21a of the TFT 21 and the drain electrode 22a of the TFT 22 are electrically connected to the drain bus line 14. The TFTs 21 and 22 are provided in parallel. A dielectric protective film (not shown) such as an SiN film is formed above the TFTs 21 and 22 so as to cover the entire substrate.

A storage capacitance bus line 18n is formed so as to extend parallel with the gate bus line 12n across the pixel area that is defined by the gate bus lines 12n and 12(n+1) and the drain bus lines 14. A storage capacitance electrode 19 is formed over the storage capacitance bus line 18n with the insulating film interposed in between (the storage capacitance electrodes 19 are provided for the respective pixels). The storage capacitance electrode 19 is electrically connected to the source electrode 21b of the TFT 21 via a connection electrode 25. A first storage capacitor Cs1 is formed between the storage capacitance bus line 18n and the storage capacitance electrode 19 which are opposed to each other via the insulating film.

The pixel area that is defined by the gate bus lines 12n and 12(n+1) and the drain bus lines 14 is divided into a subpixel A and a subpixel B. In FIG. 2, the subpixel A, which has a trapezoidal shape, for example, is disposed at the center in the top-bottom direction on the left side in the pixel area. The subpixel B occupies regions of the pixel area excluding the subpixel A, that is, a top region, a bottom region, and a central, right end region. In the pixel area, for example, the subpixels A and B are disposed so as to be approximately line-symmetrical with respect to the storage capacitance bus line 18n. A pixel electrode 16 is formed in the subpixel A, and a pixel electrode 17 which is electrically isolated from the subpixel 16 is formed in the subpixel B. Each of the pixel electrodes 16 and 17 is a transparent conductive film made of ITO or the like. The pixel electrode 16 is electrically connected to the storage capacitance electrode 19 and the source electrode 21b of the TFT 21 through a contact hole 24 which is formed through the protective film. The pixel electrode 17 is electrically connected to the source electrode 22b of the TFT 22 through a contact hole 26 which is formed through the protective film. The pixel electrode 17 has a portion that coextends with a portion of the storage capacitance bus line 18n with the protective film and the insulating film interposed in between. A second storage capacitor Cs2 is formed between those portions of the pixel electrode 17 and the storage capacitance bus line 18n which are opposed to each other via the protective film and the insulating film.

In FIG. 2, a third TFT 23 is disposed below the pixel area (the third TFTs 23 are provided for the respective pixel areas). The gate electrode of the TFT 23 is electrically connected to the next-stage gate bus line 12(n+1). An operation semiconductor layer 23c is formed over the gate electrode with the insulating film interposed in between. A channel protection film (not shown) is formed on the operation semiconductor layer 23c. A combination of a drain electrode 23a and an underlying n-type impurity semiconductor layer (not shown) and a combination of a source electrode 23b and an underlying n-type impurity semiconductor layer (not shown) are formed on the channel protection film so as to be opposed to each other with a prescribed gap.

The source electrode 23b of the TFT 23 is electrically connected to the pixel electrode 17 through a contact hole 27. A buffer capacitance electrode 28b is disposed in the vicinity of the TFT 23. The buffer capacitance electrode 28b is electrically connected, via a connection electrode 35, to a storage capacitance bus line 18(n+1) (not shown in FIG. 2) which is disposed between the gate bus line 12(n+1) and a gate bus line 12(n+2). Since all the storage capacitance bus lines 18 are given the same potential, even if the buffer capacitance electrode 28b is connected to the next-stage storage capacitance bus line 18(n+1) the potential of the buffer capacitance electrode 28b is the same as in a case that it is connected to the storage capacitance bus line 18n. A buffer capacitance electrode 28a is disposed over the buffer capacitance electrode 28b with the insulating film interposed in between. The buffer capacitance electrode 28a is electrically connected to the drain electrode 23a. The buffer capacitance electrodes 28a and 28b which are opposed to each other and that portion of the insulating film which is sandwiched between them constitute a buffer capacitance portion 28, where a buffer capacitor Cb is formed. The drain electrode 23a of the TFT 23 and the storage capacitance bus line 18(n+1) are connected to each other indirectly via the buffer capacitor Cb (capacitive coupling).

The counter substrate 4 has a CF (color filter) resin layer formed on a glass substrate and a common electrode 41 which is formed on the CF resin layer and is kept at the same potential as the storage capacitance bus lines 18. A liquid crystal having negative permittivity anisotropy, for example, is sealed between the TFT substrate 2 and the counter substrate 4 to form the liquid crystal layer. The pixel electrode 16 of the subpixel A, the common electrode 41, and that portion of the liquid crystal layer which is sandwiched between them constitute a liquid crystal capacitor Clc1, and the pixel electrode 17 of the subpixel B, the common electrode 41, and that portion of the liquid crystal layer which is sandwiched between them constitute a liquid crystal capacitor Clc2. An alignment film (vertical alignment film) is formed at the boundary between the TFT substrate 2 and the liquid crystal layer, and an alignment film (vertical alignment film) is also formed at the boundary between the counter substrate 4 and the liquid crystal layer. As a result, the liquid crystal molecules of the liquid crystal layer are aligned approximately perpendicularly to the substrate surfaces when no voltages are applied.

In the liquid crystal display device having the 3-TFT halftone structure according to the embodiment, when the gate bus line 12n is selected and the TFTs 21 and 22 are turned on, first the same voltage is applied to the liquid crystal capacitors Clc1 and Clc2 of the subpixels A and B. Then, when the next-stage gate bus line 12(n+1) is selected and the third TFT 23 is turned on, part of the charge stored in the liquid crystal capacitor Clc2 of the subpixel B moves to the buffer capacitor Cb, whereby the voltage across the liquid crystal capacitor Clc2 of the subpixel B decreases and becomes different from the voltage across the liquid crystal capacitor Clc1 of the subpixel A.

As described above, since each pixel has the subpixels A and B which are different from each other in the voltage developing across the liquid crystal layer, the distortion in the relationship between the transmittance and the voltage applied to the liquid crystal layer (T-V characteristic) is shared by the subpixels A and B. Therefore, the wash-out phenomenon (the phenomenon that an image looks whitish when viewed obliquely) can be suppressed and the viewing angle characteristic can be improved.

In the liquid crystal display device having the 3-TFT halftone structure according to the embodiment, the pixel electrode 17 of the subpixel B is connected to the drain bus line 14 via the TFT 22. Since the electrical resistance of the operation semiconductor layer 22c of the TFT 22 is much lower than that of the insulating film, the protective film, etc. even in an off state, the charge stored in the pixel electrode 17 is released easily. Therefore, according to this embodiment, no serious screen burn occurs though the halftone method is employed which provides a view viewing angle.

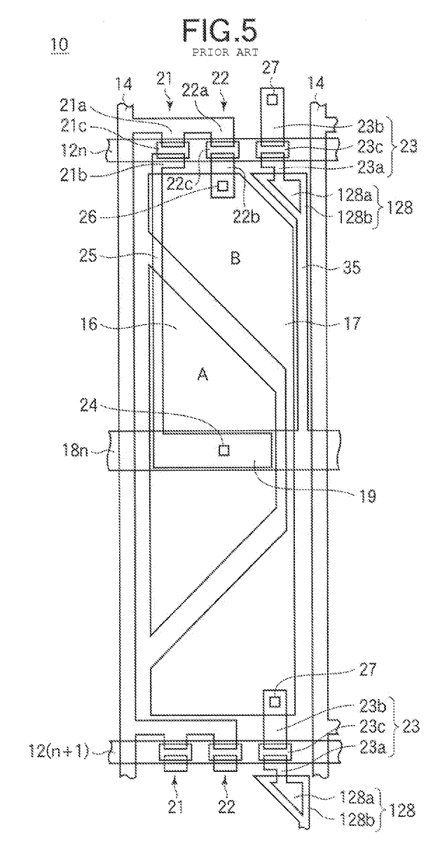

Since the buffer capacitance electrode 28a has a square shape, the liquid crystal display device according to this embodiment is less prone to be influenced by variations relating to a manufacturing process than the conventional liquid crystal display device employing the right-triangle-shaped buffer capacitance electrode 128a (see FIG. 5). As a result, high display quality without display unevenness can be obtained.

TABLE 1

| Shape of buffer | Square | | Right triangle | |
|---|---|---|---|---|
| capacitance | 1-μm | 1-μm | 1-μm | 1-μm |
| electrode | narrowing | widening | narrowing | widening |
| Design value S | 100.00 | 100.00 | 100.00 | 100.00 |
| (μm²) | | | | |
| Area of pattern | 64.00 | 144.00 | 62.05 | 146.89 |
| produced (μm²) | | | | |
| Difference (μm²) | −36.00 | 44.00 | −37.95 | 46.89 |
| Variation (%) | −36.00 | 44.00 | −37.95 | 46.89 |

Table 1 shows differences between the ways the areas of the buffer capacitance electrode 28a having a square shape and the buffer capacitance electrode 128a having a right triangle shape vary when their patterns become narrower or wider. Assume that the design values S of the areas of the buffer capacitance electrodes 28a and 128a are 100 μm². And consideration will be given to a case that their patterns become narrower by 1 μm due to over-etching in a manufacturing process. As shown in Table 1, in the case of the square buffer capacitance electrode 28a, the area of a pattern produced becomes (10-2) μm×(10-2) μm=64 μm². In the case of the right-triangle-shaped buffer capacitance electrode 128a, the area of a pattern produced becomes about 62.05 μm. Therefore, the square buffer capacitance electrode 28a is advantageous over the right-triangle-shaped buffer capacitance electrode 128a by about 1.95%.

Conversely, if the pattern of the square buffer capacitance electrode 28a becomes wider by 1 μm, the area of a pattern produced becomes (10+2) μm×(10+2) μm=144 μm². If the pattern of the right-triangle-shaped buffer capacitance electrode 128a becomes wider by 1 μm, the area of a pattern produced becomes about 146.89 μm². Therefore, the square buffer capacitance electrode 28a is advantageous over the right-triangle-shaped buffer capacitance electrode 128a by about 2.89%.

The following is understood from the above results. In the liquid crystal display device having the 3-TFT halftone structure which employs the square buffer capacitance electrode 28a, the variation of the area of the buffer capacitance electrode due to factors relating to a manufacturing process can be made smaller and the degree of display unevenness due to variations of the capacitance of the buffer capacitor Cb among the pixels can be made lower than in the conventional liquid crystal display device having the right-triangle-shaped buffer capacitance electrode 128a (see FIG. 5).

### Second Embodiment

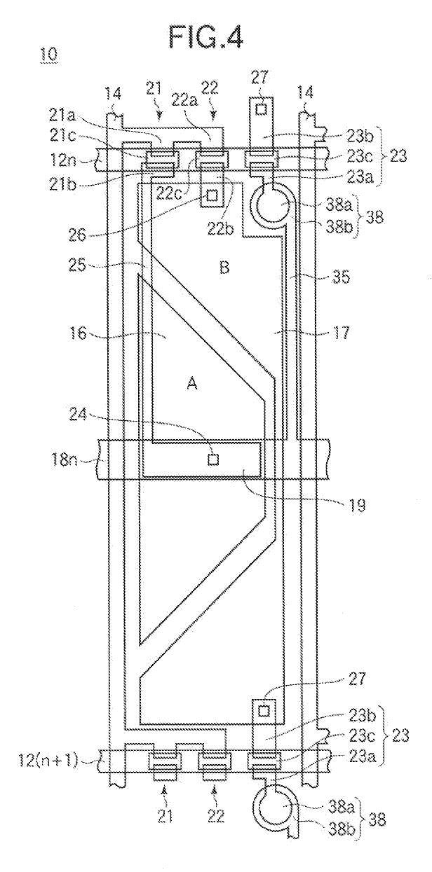

A liquid crystal display device according to a second embodiment of the invention will be described below with reference to FIG. 4. FIG. 4 shows a one-pixel configuration of the liquid crystal display device according to this embodiment. In the following description of the liquid crystal display device according to the embodiment, components that provide the same functions or workings as the corresponding components of the first embodiment will be given the same reference symbols as the latter and will not be described in detail.

In the liquid crystal display device according to the embodiment, circular buffer capacitance electrodes 38a and 38b are provided in place of the square circular buffer capacitance electrodes 28a and 28b of the first embodiment.

The buffer capacitance electrode 38b is electrically connected, via the connection electrode 35, to the storage capacitance bus line 18(n+1) (not shown in FIG. 4) which is disposed between the gate bus lines 12(n+1) and 12 (n+2). The buffer capacitance electrode 38a is electrically connected to the drain electrode 23a. The buffer capacitance electrodes 38a and 38b which are opposed to each other and that portion of the insulating film sandwiched between them constitute a buffer capacitance portion 38, where a buffer capacitor Cb is formed. The drain electrode 23a of the TFT 23 and the storage capacitance bus line 18(n+1) are connected to each other indirectly via the buffer capacitor Cb (capacitive coupling).

Since the buffer capacitance electrode 38a has a circular shape, the liquid crystal display device according to this embodiment is less prone to be influenced by variations relating to a manufacturing process than the conventional liquid crystal display device employing the right-triangle-shaped buffer capacitance electrode 128a (see FIG. 5). As a result, high display quality without display unevenness can be obtained.

TABLE 2

| Shape of | | | | | | |
|---|---|---|---|---|---|---|
| buffer | Circle | | Square | | Right triangle | |
| capacitance | 1-μm | 1-μm | 1-μm | 1-μm | 1-μm | 1-μm |
| electrode | narrowing | widening | narrowing | widening | narrowing | widening |
| Design value | 100.00 | 100.00 | 100.00 | 100.00 | 100.00 | 100.00 |
| S (μm²) | | | | | | |
| Area of | 67.60 | 138.44 | 64.00 | 144.00 | 62.05 | 146.89 |
| pattern | | | | | | |
| produced (μm²) | | | | | | |
| Difference | −32.40 | 38.44 | −36.00 | 44.00 | −37.95 | 46.89 |
| (μm²) | | | | | | |
| Variation (%) | −32.40 | 38.44 | −36.00 | 44.00 | −37.95 | 46.89 |

Table 2 shows differences between the areas of the buffer capacitance electrode 38a having a circular shape, the buffer capacitance electrode 28a having a square shape, and the buffer capacitance electrode 128a having a right triangle shape. Assume that the design values S of the areas of the buffer capacitance electrodes 38a, 28a and 128a are 100 μm². And consideration will be given to a case that their patterns become narrower by 1 μm due to over-etching in a manufacturing process. As shown in Table 2, the area of a pattern produced becomes about 67.6 μm² in the case of the circular buffer capacitance electrode 38a and about 62.05 μm² in the case of the right-triangle-shaped buffer capacitance electrode 128a. Therefore, the circular buffer capacitance electrode 38a is advantageous over the right-triangle-shaped buffer capacitance electrode 128a by about 5.55%.

Conversely, if the patterns of the buffer capacitance electrodes become wider by 1 μm, the area of a pattern produced becomes about 138.44 μm² in the case of the circular buffer capacitance electrode 38a and about 146.89 μm² in the case of the right-triangle-shaped buffer capacitance electrode 128a. Therefore, the circular buffer capacitance electrode 38a is advantageous over the right-triangle-shaped buffer capacitance electrode 128a by about 8.45%.

The following is understood from the above results. In the liquid crystal display device having the circular buffer capacitance electrode 38a, the variation of the area of the buffer capacitance electrode 38a due to factors relating to a manufacturing process can be made smaller and the degree of display unevenness due to variations of the capacitance of the buffer capacitor Cb among the pixels can be made lower than in the conventional liquid crystal display device having the right-triangle-shaped buffer capacitance electrode 128a (see FIG. 5).

As described above, in the liquid crystal display device having the 3-TFT halftone structure, the invention can suppress the variation of the capacitance of the buffer capacitor Cb which is a cause of the display unevenness. This makes it possible to realize a liquid crystal display device having a wide viewing angle which is not prone to screen burning and can provide, in a stable manner, display characteristics that are free of display unevenness. Although basically the pixel configurations of the above embodiments are ones devised bearing in mind that they are applied to a liquid crystal display device of the VA mode such as the MVA mode, it is not that the principle of operation and the advantages of the invention are effective only in VA-mode liquid crystal display devices, but that they are effective in liquid crystal display devices of any liquid crystal mode such as the TN mode, IPS mode, or the OCB mode.

The invention is not limited to the above embodiments and various modifications are possible.

For example, although the above embodiments employ the square buffer capacitance electrodes 28a and 28b or the circular buffer capacitance electrodes 38a and 38b, the invention is not limited to these cases. Buffer capacitance electrodes that are shaped like a regular polygon having five or more sides may be used.

Although the above embodiments are directed to the liquid crystal display devices in which the buffer capacitance electrode 28b or 38b is electrically connected to the storage capacitance bus line 18(n+1) which is disposed between the gate bus lines 12(n+1) and 12 (n+2) through a connection electrode 35, the invention is not limited to such a case. The invention can also be applied to a liquid crystal display device in which the buffer capacitance electrode 28b or 38b is electrically connected to the storage capacitance bus line 18n which is disposed between the gate bus lines 12n and 12(n+1).

Although the above embodiments are directed to the transmission-type liquid crystal display devices, the invention is not limited to such a case. The invention can also be applied to liquid crystal display devices of other types such as the reflection type and the transflective type.

Although the above embodiments are directed to the liquid crystal display devices in which the CF resin layer is formed in the counter substrate 4, the invention is not limited to such a case. The invention can also be applied to a liquid crystal display device having what is called a CF-on-TFT structure in which a CF resin layer is formed in the TFT substrate 2.

What is claimed is:

1. A liquid crystal display device comprising:
plural gate bus lines formed on a substrate so as to extend parallel with each other;
plural drain bus lines which cross the gate bus lines with an insulating film interposed in between;
plural storage capacitance bus lines extending parallel with the gate bus lines;
first and second thin-film transistors disposed in the vicinity of a crossing point of an nth gate bus line and one of the drain bus lines;
a first pixel electrode electrically connected to the first thin-film transistor;
a second pixel electrode electrically connected to the second thin-film transistor and separated from the first pixel electrode;
a third thin-film transistor which is disposed in the vicinity of a crossing point of an (n+1)th gate bus line and another of the drain bus lines and whose source or drain electrode is electrically connected to the second pixel electrode; and
a buffer capacitance portion comprising a first buffer capacitance electrode which is electrically connected to the drain or source electrode of the third thin-film transistor and shaped like a regular polygon having four or more sides, and a second buffer capacitance electrode which is opposed to the first buffer capacitance electrode via the insulating film, electrically connected to one of the storage capacitance bus lines, and shaped like a regular polygon having four or more sides.

2. The liquid crystal display device according to claim 1, wherein a circular first buffer capacitance electrode is provided in place of the first buffer capacitance electrode shaped like a regular polygon having four or more sides, and a circular second buffer capacitance electrode is provided in place of the second buffer capacitance electrode shaped like a regular polygon having four or more sides.
